(19) United States
(12) Patent Application Publication
(10) Pub. No.: US 2026/0269518 A1
(43) Pub. Date: Sep. 10, 2026

(54) IMMERSION COOLING SYSTEM AND WORKING FLUID THEREOF

(71) Applicant: Taiwan Ruomei Technology Corp., TAIPEI (TW)

(72) Inventors: HOU-YU LEE, TAIPEI (TW); Si-Han LIN, TAIPEI (TW)

(73) Assignee: Taiwan Ruomei Technology Corp., TAIPEI (TW)

(21) Appl. No.: 19/557,138

(22) Filed: Mar. 5, 2026

(30) Foreign Application Priority Data
Mar. 7, 2025 (TW) 114202304

(51) Int. Cl. H01R 13/533; H01R 12/72

(52) U.S. Cl. CPC H01R 13/533; H01R 12/722

(57) ABSTRACT

A connector with a heat dissipation function, includes: a conduction terminal set; an insulation plastic block, including a terminal accommodation structure for encapsulating a portion of the conduction terminal set; and a metal shell, including a top wall and two sidewalls connected to the top wall, wherein an accommodation space is surrounded by the top wall and the sidewalls, and the insulation plastic block is disposed in the accommodation space. The material of the insulation plastic block includes an alumina-boron nitride-fullerene composite material. The alumina-boron nitride-fullerene composite material transmits heat from the insulation plastic block into the outside of the insulation plastic block, by lattice resonance inside the alumina-boron nitride-fullerene composite material and by radiation heat dissipation on the outer surface of the alumina-boron nitride-fullerene composite material.

### CROSS REFERENCE

The present invention claims priority to TW114202304 filed on March 7, 2025.

### BACKGROUND OF THE INVENTION

### Field of Invention

The present invention provides a connector with a heat dissipation function, especially the connector having capability of transferring the waste heat inside the connector to the outside by radiation heat dissipation.

### Description of Related Art

The conventional connectors usually consume less energy due to a lower signaling load, and they generate little waste heat with a limited temperature increase. A dedicated heat sink is not necessary for maintaining normal operation of the conventional connectors with the limited temperature increase. When the temperature increase in the connector is higher, the connector can be encapsulated with heat-stable materials, to maintain the normal operation. Nowadays, the amount of data transferred through connectors is getting larger and larger, and the conventional connector technology is possibly incapable of meeting the high heat dissipation requirements for normal operation. When the operating temperature of the connector is kept high for a long period of time, the encapsulation material is easy to deteriorate, and the contact between different materials is possibly to fall off and deform, which may result in the shortening of the service life of the connector. Therefore, under the large signal transmission, it is essentially important to improve the heat dissipation capability of the connector.

### SUMMARY OF THE INVENTION

In view of the aforementioned high data transmission requirement, the present invention provides a connector with a heat dissipation function. The connector includes: a conduction terminal set; an insulation plastic block, having a terminal accommodation structure for encapsulating a portion of the conduction terminal set; and a metal shell, including a top wall and two sidewalls connected to the top wall, wherein an accommodation space is substantially surrounded by the top wall and the sidewalls, and the insulation plastic block is disposed in the accommodation space. The material of the insulation plastic block includes an alumina-boron nitride-fullerene composite material. The alumina-boron nitride-fullerene composite material transfers the waste heat from the insulation plastic block into the outside of the insulation plastic block, by lattice resonance inside the alumina-boron nitride-fullerene composite material and radiation heat dissipation on the outer surface of the alumina-boron nitride-fullerene composite material.

In one embodiment, the connector is a board-side connector, which abuts on a circuit board. In one embodiment, the insulation plastic block in the board-side connector, includes at least a positioning bump, which is positioned to be aligned with at least one positioning hole on the circuit board, and the insulation plastic block is thereby secured on the circuit board. In one embodiment, the sidewalls of the metal shell include at least one sidewall engaging portion, which is positioned into at least one alignment locking portion on the circuit board.

In one embodiment, a surface of the metal shell is covered with a thermal dissipation material, a composition of which includes an alumina oxide-boron nitride-fullerene composite material, to transfer the waste heat from the metal shell to the outside of the metal shell, by the lattice resonance in the alumina-boron nitride-fullerene composite material and by the radiation heat dissipation on the outer surface of the alumina-boron nitride-fullerene composite material.

In one embodiment, the surface of the metal shell includes at least one conductive surface region, which is not covered with the thermal dissipation material.

In one embodiment, the connector can be a wire-side connector; the conduction terminal set of the wire-side connector is electrically connected to a circuit board by wiring. In one embodiment, the metal shell of the wire-side connector can further include a bottom wall that is connected to the sidewalls, wherein the accommodation space is surrounded by the top wall, the sidewalls, and the bottom wall. The insulation plastic block is disposed in the accommodation space.

In one embodiment, the wire-side connector is covered with an encapsulation material. In a manufacturing step of the wire-side connector, the encapsulation material covers the conduction terminal set, the insulation plastic block, the metal shell, and a portion of the wire. After a curing process, the encapsulation material defines an outer surface of the wire-side connector. A composition of the encapsulation material includes the alumina-boron nitride-fullerene composite material, which transfers the waste heat from the insulation plastic block to the outside of the wire-side connector, by the lattice resonance in the alumina-boron nitride-fullerene composite material and by the radiation heat dissipation on the outer surface of the alumina-boron nitride-fullerene composite material.

In one embodiment, the encapsulation material covers the conduction terminal set, the insulating plastic block, the metal shell, and a portion of the wire, by a process of insert molding or over molding.

In one embodiment, the outer surface of the wire includes a covering material. A composition of the covering material includes the alumina-boron nitride-fullerene composite material, and the waste heat in the wire is essentially transferred to the outside of the wire, substantially by the lattice resonance in the alumina-boron nitride-fullerene composite material and by the radiation heat dissipation of the alumina-boron nitride-fullerene composite material on the outer surface of the covering material.

In one embodiment, the alumina-boron nitride-fullerene composite material includes a plurality of composite microparticles. In each of the composite microparticles, the alumina is disposed at the center of each of the composite microparticles and encircled by plural sandwich structures. Each of the sandwich structures includes a composition disposition sequence of boron nitride, fullerene, and boron nitride.

In one embodiment, the composite microparticles have a preferable particle size ranging between 0.01 μm and 60 μm.

In one embodiment, the fullerene includes a C60 molecular structure in a long capsule-like shape.

In one embodiment, the weight percentage of the alumina-boron nitride-fullerene composite material in the insulation material, ranges from 2% to 30%, and is more preferably around 10%.

In one embodiment, the connector with heat dissipation, includes a small form-factor pluggable (SFP) connector, or a giga bitrate interface converter (GBIC) connector.

In one embodiment, the metal shell includes a lateral opening, and a surface of the insulation plastic block is provided with a plurality of slanted grooves, wherein at least a portion of the surfaces of the slanted grooves, in their normal directions, are substantially oriented toward the lateral opening.

In one embodiment, at least one of the top wall, the sidewalls, and the bottom wall of the metal shell includes at least one auxiliary ramp, to guide an engageable connector to be aligned for engaging or inserting into the connector of the present invention, thereby enabling electrical connection between the engageable connector and the conduction terminal set of the present invention.

The objectives, technical details, features, and benefits of the present invention can be better understood with regard to the detailed description of the embodiments below, with reference to the associated drawings.

### BRIEF DESCRIPTION OF THE DRAWINGS

FIGS. 1 and 2 show a schematic diagram of the connector with the heat dissipation function according to one embodiment of the present invention.

FIG. 3 shows a schematic diagram of the integrated structure of the conduction terminal set and the insulation plastic block, according to one embodiment of the present invention.

FIG. 4 shows a schematic diagram of the metal shell according to one embodiment of the present invention.

FIG. 5 shows a schematic diagram of the board-side connector abutting the circuit board according to one embodiment of the present invention.

FIG. 6 and 7 show schematic diagrams of the board-side connector covered with the thermal dissipation material according to one embodiment of the present invention.

FIG. 8 shows a schematic diagram of the wire-side connector according to one embodiment of the present invention.

FIG. 9 shows a schematic diagram of the composite microparticle of the alumina-boron nitride-fullerene composite material according to one embodiment of the present invention.

FIG. 10 shows a schematic diagram of the sandwich structure in the alumina-boron nitride-fullerene composite material according to one embodiment of the present invention.

FIG. 11 shows a schematic diagram of the molecular structure in a long capsule-like shape of the fullerene according to one embodiment of the present invention.

FIG. 12 shows a schematic diagram of the slanted grooves on the insulation plastic block according to one embodiment of the present invention.

### DESCRIPTION OF THE PREFERRED EMBODIMENTS

The objectives, technical details, features, and effects of the present invention can be better understood with regard to the detailed description of the embodiments below, with reference to the associated drawings. The technical wordings/terms in this specification are based on a customary understanding of the art. In this specification, the interpretations of these wordings/terms are preferentially based on the description or the definition in this specification. Each embodiment of the present invention includes at least one technical feature. To the extent possible, a person having ordinary knowledge in the art may, as needed, select, combine, or modify some or all of the technical features in any one of the embodiments, within the spirit and scope of the present invention.

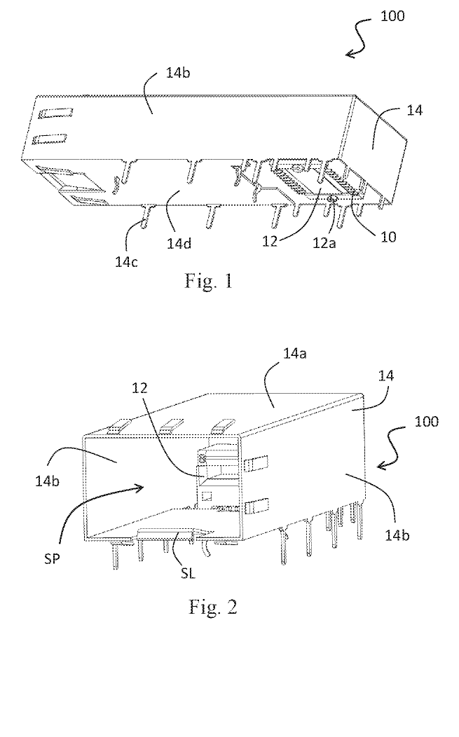

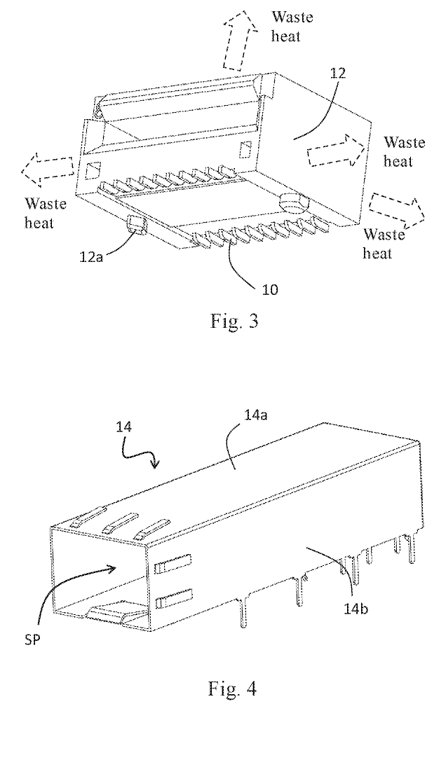

In view of the aforementioned demands for high signal transmission operation, as shown in FIGS. 1 and 2, the present invention provides a connector 100 with a high-efficiency heat dissipation function. The connector 100 includes: a conduction terminal set 10; an insulation plastic block 12, made of an insulation material, and having a terminal accommodation structure (a space within the insulation plastic block 12), to encapsulate a portion of the conduction terminal set 10, wherein the conduction terminal set 10 is disposed within the terminal accommodation structure to establish precise contact with an engageable connector for signal transmission, and an integrally bonded structure of the conduction terminal set 10 and the insulation plastic block 12 is accordingly formed (FIG. 3); and a metal shell 14, having a top surface 14a and sidewalls 14b connected to the top surface 14a, wherein an accommodation space SP is formed between the top surface 14a and the sidewalls 14b, to dispose the insulation plastic block 12 within the accommodation space SP (FIGS. 2 and 4). The material composition of the insulation plastic block 12 includes an alumina–boron nitride–fullerene composite material (detailed in the following embodiments). The alumina–boron nitride–fullerene composite material dissipates the waste heat of the insulation plastic block 12 to the exterior (outside) of the insulation plastic block 12 by internal lattice resonances and surface thermal radiation of the alumina–boron nitride–fullerene composite material (as shown in FIG. 3, or, directly to the outside of the connector 100, or transmitted to the metal shell 14). The lattice resonance (also known as lattice thermal conduction) refers to the transmission of heat through propagation of the atomic lattice vibration within the material. In insulation materials, the lattice thermal conduction is one of heat transfer modes. The increase of the lattice thermal conduction is proportional to the temperature gradient of the material. A longer wavelength of the lattice resonances can achieve a longer heat transfer penetration distance. In addition, the thermal radiation refers to the surface heat transfer on an object, via electromagnetic radiation. The degree of heat radiation is proportional to the surface area, emissivity, and the fourth power of the absolute temperature of the object. According to the present invention, a superior heat dissipation performance can be achieved with a special material composition ratio and/or disposition arrangement of the alumina–boron nitride–fullerene composite material.

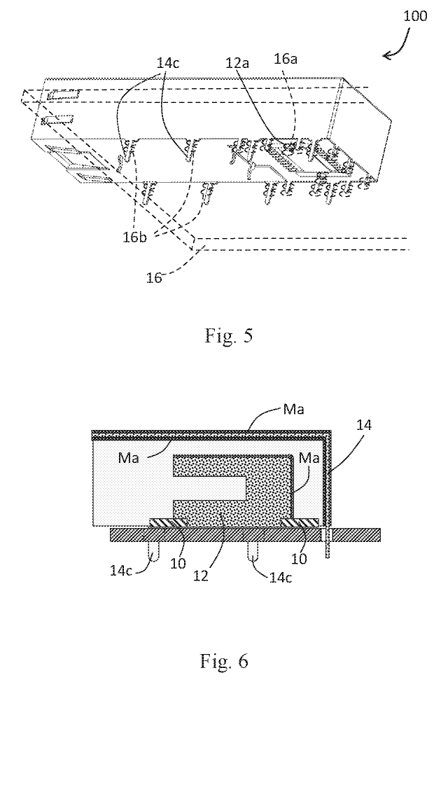

In the embodiment as shown in FIG. 5, the connector 100 is a board-side connector, used for signal communication with a circuit board 16 (illustrated schematically by dashed lines in the figures). The board-side connector abuts on the circuit board 16. In one embodiment, the insulation plastic block 12 of the board-side connector includes at least one positioning bump 12a, wherein at least one positioning bump is aligned to at least one positioning hole 16a on the circuit board 16 (the positioning holes 16a are illustrated schematically by dashed lines), to assist in disposing the board-side connector on the circuit board 16 and to provide a mechanical strength support during insertion and removal of the connector, thereby preventing moving or solder joint failure of the board-side connector on the circuit board 16. In another embodiment, the sidewalls 14b of the metal shell 14 include at least one sidewall engaging portion 14c, wherein at least one sidewall engaging portion 14c is aligned to be positioned within at least one alignment locking portion 16b on the circuit board 16. This engagement between the sidewall engaging portion 14c and the alignment locking portion 16b enhances the positioning accuracy between the board-side connector and the circuit board 16. After soldering between the sidewall engaging portion 14c and the alignment locking portion 16b, the metal shell 14 can further provide physical functions such as EMI shielding and a larger grounding area connected to the circuit board 16. Moreover, the alignment locking portion 16b can also be made of a high thermal conductivity material to transfer waste heat from the metal shell 14 outward via thermal conduction.

FIG. 6 illustrates a schematic diagram of an embodiment in which a surface of the metal shell 14 of the board-side connector is covered with a thermal dissipation material Ma (the metal shell 14 is illustrated without the bottom wall 14d as an example). The thermal dissipation material Ma includes the alumina–boron nitride–fullerene composite material. The waste heat inside the metal shell 14 is primarily transferred to the exterior of the metal shell 14 through the lattice resonance and the thermal radiation of the alumina–boron nitride–fullerene composite material. The thermal dissipation material Ma can be covered on the metal shell 14 by various methods, such as ink covering or spraying.

Continuing to refer to FIG. 6, in one embodiment, the thermal dissipation material Ma can cover the insulation plastic block 12 by ink covering, by printing in specific patterns or spraying, to increase surface roughness or surface microstructures, thereby expanding the heat radiation area or increasing the radiation emission angle range. The weight percentages of the alumina–boron nitride–fullerene composite materials included in the thermal dissipation material Ma and the insulation plastic block 12 may differ from each other, for heat dissipation performance or cost balance. In one embodiment, the insulation plastic block 12 may not be covered with the thermal dissipation material Ma, which depends on the application requirements.

FIG. 7 illustrates one embodiment wherein the surface of the metal shell 14 of the board-side connector includes at least one conductive surface region Rco. The conductive surface region Rco is not covered with the thermal dissipation material and directly exposed on the surface of the metal shell 14. By electrically contacting other conductive material/interface with the conductive surface region Rco to form a grounding path, the metal shell 14 can provide functions of signal shielding, reducing external signal interference, and minimizing electromagnetic radiation. Further, the metal shell 14 can offer a larger physical reception area for dissipating/absorbing static charges, thereby decreasing the impact of external static electricity on the circuit board 16. As shown in FIG. 7, the insulation plastic block 12 may not be covered with the thermal dissipation material Ma.

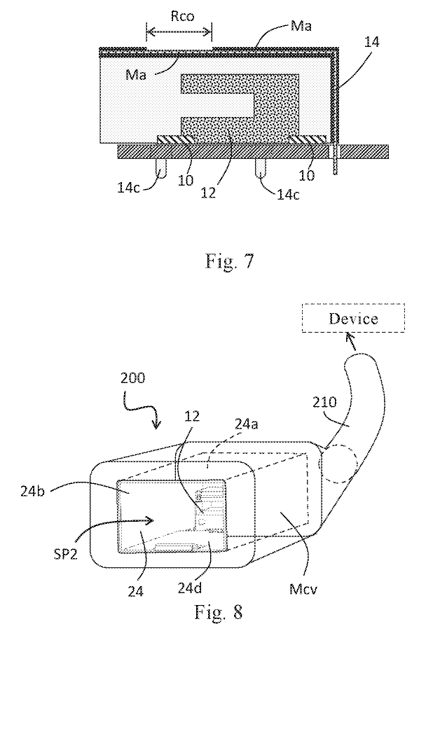

The feature of the present invention can be not limited to the board-side connector. Referring to FIG. 8, the connector according to the present invention can also be implemented as a wire-side connector 200. The wire-side connector 200 can be disposed outside a device (not shown) and electrically connected to the device through a wire 210, wherein the plugging and unplugging arrangement can be flexibly adjusted, thus saving disposition space for the board-side connector on the circuit board. In one embodiment, the wire-side connector 200 includes a conduction terminal set (similar in design to the conduction terminal set 10, for precise contact with another engageable connector for signal transmission) that is electrically connected to a circuit board 16 through the wire 210. In one embodiment, the metal shell 24 of the wire-side connector further includes a bottom wall 24d connected to sidewalls 24b, wherein an accommodation space SP2 is defined by the top wall 24a, the sidewalls 24b, and the bottom wall 24d. The insulation plastic block 12 is disposed within the accommodation space SP2. The bottom wall 24d can be optional and may be replaced by another circuit board (not shown) according to the design and requirements.

In one embodiment, the wire-side connector 200 includes an encapsulation material Mcv. The encapsulation material Mcv surrounds and encapsulates the conduction terminal set, the insulation plastic block 12, the metal shell 14, and a portion of the wire 210, in the manufacturing process of the wire-side connector 200. After a curing process, the encapsulation material Mcv forms an outer surface of the wire-side connector 200. The encapsulation material Mcv includes the alumina–boron nitride–fullerene composite material, and the waste heat from the insulation plastic block 12 (inside the wire-side connector 200) is transferred to the exterior of the wire-side connector 200, primarily through lattice resonances and surface radiation of the alumina–boron nitride–fullerene composite material.

According to one embodiment, the manufacturing process includes an insert molding process or an over-molding process of the encapsulation material Mcv surrounding and encapsulating the conduction terminal set 10, the insulation plastic block 12, the metal shell 14, and a portion of the wire. These two molding techniques are well known, and the related descriptions thereof are not detailed herein.

In one embodiment, the surface of the wire 210 includes a covering material (not shown) that covers the internal conductive wire portion of the wire 210. The material composition of the covering material includes the alumina–boron nitride–fullerene composite material. The waste heat inside the wire 210 is transferred to the exterior of the wire 210, primarily through the internal lattice resonances and the surface thermal radiation of the alumina–boron nitride–fullerene composite material. Further, the heat generated by high-speed signal transmission within the wire 210, usually propagates along the wire 210 (e.g., copper or aluminum wires with high electrical and high thermal conductivity). In conventional technologies of the tightly enclosing covering material on the wire, whose heat dissipation capability is poor. The accumulated heat can deteriorate the covering material over long-term working time, causing internal voids or shortening the service life of the wire. The covering material of the present invention significantly improves these problems.

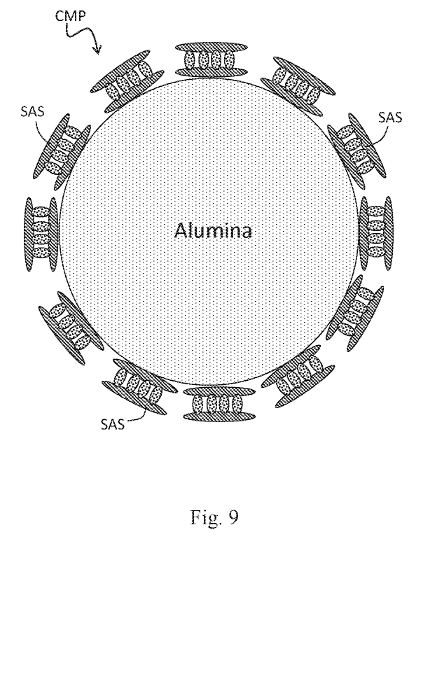

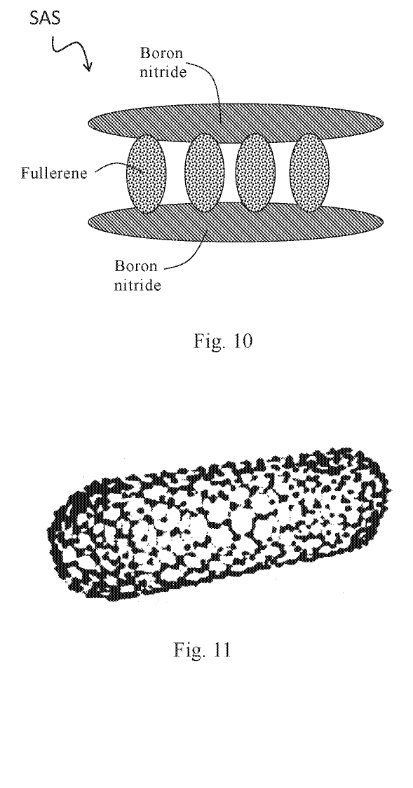

Referring to FIG. 9, in one embodiment, the alumina–boron nitride–fullerene composite material includes a plurality of composite microparticles CMP. In each of the composite microparticles CMP, the alumina is located at the center of the composite microparticle CMP, wherein the alumina is encircled by a number of sandwich structures SAS (the number of the sandwich structures SAS in the drawing is only illustrative). Each of the sandwich structures SAS includes a composition disposition sequence of boron nitride, fullerene, and boron nitride, in which the sides of the sandwich structures SAS facing the alumina dispose the boron nitrides (referring to FIG. 10). In the sandwich structure SAS, the boron nitride and the fullerene may have different disposition alignment directions (the direction in the longer dimension of a long capsule-like shape of the fullerene, is different from the direction in the longer dimension of the boron nitride), wherein the fullerenes are disposed between the two boron nitrides, and the number of fullerenes shown in the drawings is only illustrative. These composite materials can be manufactured in a physical or chemical way. The fullerene of the present invention has a C60 molecular formula (a molecular structure composed of sixty carbon atoms). The fullerene applied in the present invention has the long capsule-like molecular structure. The fullerene in the long capsule-like shape has an excellent performance of thermal radiation and electrical conductivity. In the sandwich structures SAS, the two boron nitrides surround the fullerene, to isolate the conductivity between neighboring groups of the fullerenes. Therefore, the sandwich structures SAS have excellent thermal radiation and electrical isolation capability. The capsule-shaped fullerene applied in the current invention can have a high surface emissivity of 0.98 (ε in the surface emissivity in the aforementioned thermal radiation formula). In one embodiment, the particle size of the CMPs preferably ranges from 0.01 μm to 60 μm.

In the sandwich structures SAS (FIG. 10), the boron nitrides and fullerenes in the sandwich structure SAS can attract each other by π-π interaction between the boron nitride and fullerene. The π-π bond interaction reacts between the π electron cloud on the surface of fullerene and the π electron cloud on the surface of boron nitride, whereby the fullerene and the boron nitride attract each other and connect to each other. In one embodiment, the fullerenes can be functionalized to include hydroxyl groups, and the boron nitrides can be functionalized to include hydroxyl groups with hydroxyl-functionalized boron atoms (B-OH) on the surfaces of the boron nitrides. The fullerenes and the boron nitrides are attracted to connect each other between the hydrogen bonds of the hydroxyl groups of the fullerenes and the boron nitrides. In addition, the aluminum atoms in the composite particle CMP are respectively functionalized to include hydroxyl-functionalized aluminum atoms (Al-OH) with hydroxyl groups on the surfaces of the alumina. This aluminum-hydroxyl group and the boron-hydroxyl group (located on the surface of the sandwich structure SAS) interact in the composite particle, wherein the hydrogen bonds of the composite particle CMP and the sandwich structure SAS, attract each other. The interconnected boron nitrides and fullerenes in the sandwich structure SAS, and the interconnected alumina and sandwich structure SAS in the composite particle CMP, can form a stably combined sandwich structure SAS and build stable adhesion through a liquid arc process.

In one embodiment, after chemical functionalization reaction, the alumina in the composite microparticles CMP forms aluminum–hydroxyl groups (Al–OH) on its surface. These aluminum–hydroxyl groups have hydrogen bond attraction with the boron–hydroxyl groups on the surfaces of the sandwich structures SAS, thereby connecting the composite particles CMP and the sandwich structures SAS through mutual attraction (FIG. 9).

In the aforementioned embodiments, the stable bonding in the sandwich structures SAS (connecting boron nitride and fullerene) and the stable bonding in the composite microparticles CMP (connecting alumina and sandwich structures SAS) are achieved through the liquid arc process.

Referring to FIG. 11, in one embodiment, the fullerene includes a C60 molecular structure in the long capsule-like shape.

In one embodiment, the weight percentage of the alumina–boron nitride–fullerene composite material in the material composition of the insulation plastic block 12, preferably ranges from 2% to 30%, with 10% being the most preferred.

In one embodiment, the board-side connector 100 or the wire-side connector 200 can be a small form-factor pluggable (SFP) connector, or a giga bitrate interface converter (GBIC) connector.

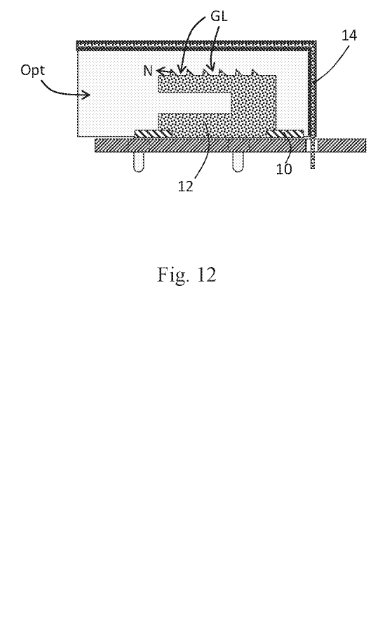

Please refer to FIG. 12, in one embodiment, the metal shell 14 of the board-side connector (or the metal shell of the wire-side connector) includes a lateral opening Opt (illustrated by the board-side connector as an example). The insulation plastic block 12 has multiple slanted grooves GL, wherein the normal direction N of at least a portion of the surfaces of the slanted grooves GL is substantially oriented toward the lateral opening Opt. Since the intensity of thermal radiation varies with the radiation angle, the waste heat inside the insulation plastic block 12 is predominantly radiated outward along the normal direction N. This radiation is emitted through the lateral opening Opt, thereby achieving optimal thermal radiation dissipation.

Please refer to FIG. 2, in one embodiment, at least one auxiliary ramp SL is provided on at least one of the top wall, the sidewalls, or the bottom wall of the metal shell 14. The auxiliary ramp SL can guide an engageable connector into alignment with the connector and adjusts the position of the engageable connector for proper electrical connection to the conduction terminal set. Or, the auxiliary ramp SL can electrically contact the metal shell of the engageable connector to provide functions of grounding, signal shielding, reduction of external signal interference, and suppression of electromagnetic radiation.

The present invention has been disclosed with reference to the above embodiments, which are not intended to limit the spirit and scope of the present invention. A person skilled in the art to which the present disclosure pertains may make various modifications and adjustments without departing from the spirit and scope of the present disclosure. Accordingly, the scope of protection of the present invention can be defined by the claims.

What is claimed is:

1. A connector with heat dissipation function, including:
a conduction terminal set;
an insulation plastic block, whose material includes an insulation material, the insulation plastic block including a terminal accommodation structure to encapsulate a portion of the conduction terminal set; and
a metal shell, including a top wall and two sidewalls connected to the top wall, wherein the top wall and the two sidewalls form an accommodation space, and the insulation plastic block is disposed in the accommodation space;
wherein, the insulation material includes an alumina-boron nitride-fullerene composite material, which transfers the waste heat in the insulation plastic block by lattice resonance in the interior of the alumina-boron nitride-fullerene composite material and by radiation heat dissipation on the outer surface of the alumina-boron nitride-fullerene composite material, respectively.

2. The connector with heat dissipation function according to claim 1, wherein the connector is a board-side connector, to abut on a circuit board.

3. The connector with heat dissipation function according to claim 2, wherein the insulation plastic block in the board-side connector, includes at least a positioning bump, which is positioned to be aligned with at least one positioning hole on the circuit board; and
wherein, the sidewalls of the metal shell include at least one sidewall engaging portion, which is positioned into at least one alignment locking portion on the circuit board.

4. The connector with heat dissipation function according to claim 3, wherein the positioning hole on the circuit board is formed by a high heat transfer material, and a portion of the waste heat from the insulation plastic block is transferred to the outside of the circuit board, through the positioning bump, the positioning hole and the circuit board.

5. The connector with heat dissipation function according to claim 1, wherein a surface of the metal shell is covered with a thermal dissipation material, a composition of which includes an alumina oxide-boron nitride-fullerene composite material, to transfer the waste heat from the metal shell to the outside of the metal shell, by the lattice resonance in the alumina-boron nitride-fullerene composite material and by the radiation heat dissipation on the outer surface of the alumina-boron nitride-fullerene composite material, wherein the surface of the metal shell includes at least one conductive surface region, which is not covered with the thermal dissipation material.

6. The connector with heat dissipation function according to claim 1, wherein the connector is a wire-side connector, the conduction terminal set of the wire-side connector is electrically connected to a circuit board by wiring.

7. The connector with heat dissipation function according to claim 6, wherein the metal shell further includes a bottom wall that is connected to the sidewalls, wherein the accommodation space is surrounded by the top wall, the sidewalls, and the bottom wall, and the insulation plastic block is disposed inside the accommodation space.

8. The connector with heat dissipation function according to claim 6, wherein the wire-side connector is covered with an encapsulation material; in a manufacturing step of the wire-side connector, the encapsulation material covers the conduction terminal set, the insulation plastic block, the metal shell, and a portion of the wire; and, after curing, the encapsulation material defines the outer surface of the wire-side connector;
wherein a composition of the encapsulation material includes the alumina-boron nitride-fullerene composite material, which transfers the waste heat from the insulation plastic block to the outside of the wire-side connector, by the lattice resonance in the alumina-boron nitride-fullerene composite material and by the radiation heat dissipation on the outer surface of the alumina-boron nitride-fullerene composite material; and
wherein the encapsulation material covers the conduction terminal set, the insulating plastic block, the metal shell, and a portion of the wire, by a process of insert molding or over molding.

9. The connector with heat dissipation function according to claim 6, wherein the outer surface of the wire includes a covering material, wherein a composition of the covering material includes the alumina-boron nitride-fullerene composite material, and the waste heat in the wire is essentially transferred to the outside of the wire, by the lattice resonance in the alumina-boron nitride-fullerene composite material and by the radiation heat dissipation of the alumina-boron nitride-fullerene composite material on the outer surface of the covering material.

10. The connector with heat dissipation function according to claim 1, wherein the alumina-boron nitride-fullerene composite material includes a plurality of composite microparticles, wherein in each of the composite microparticles, the alumina is disposed at the center of each of the composite microparticles and encircled by plural sandwich structures, and each of the sandwich structures includes a composition disposition sequence of boron nitride, fullerene, and boron nitride, wherein the composite microparticles have a preferable particle size ranging between 0.01 μm and 60 μm, the fullerene includes a C60 molecular structure in a long capsule-like shape, and the weight percentage of the alumina-boron nitride-fullerene composite material in the insulation material ranges from 2% to 30%.

11. The connector with heat dissipation function according to claim 1, wherein the connector with the heat dissipation, includes a small form-factor pluggable (SFP) connector, or a giga bitrate interface converter (GBIC) connector.

12. The connector with heat dissipation function according to claim 1, wherein the metal shell includes a lateral opening, and a plurality of slanted grooves are disposed on a surface the insulation plastic block, wherein at least a portion of the surfaces of the slanted grooves, in their normal directions, are substantially oriented toward the lateral opening; and
wherein at least one of the top wall, the sidewalls, and the bottom wall of the metal shell, includes at least one auxiliary ramp, for guiding an engageable connector to be aligned for engaging or inserting into the connector with the heat dissipation function, thereby enabling electrical connection between the engageable connector and the conduction terminal set.
